(19) United States
(12) Patent Application Publication
(10) Pub. No.: US 2012/0328981 A1
(43) Pub. Date: Dec. 27, 2012

(54) PREPARATION METHOD FOR TONER BY USING ALKALI-SOLUBLE RESIN CONTAINING ACIDIC GROUP

(75) Inventors: Il Hyuk Kim, Daejeon-city (KR); Ji Sang Jeong, Daejeon-city (KR); Ha Na Jung, Seoul (KR); Sung Hwa Lee, Daegu-city (KR); Kyung Gyol Yon, Seongnam-si (KR)

(73) Assignee: SAMSUNG FINE CHEMICALS CO., LTD., Ulsan (KR)

(21) Appl. No.: 13/579,407

(22) PCT Filed: Feb. 16, 2011
(86) PCT No.: PCT/KR2011/001012

§ 371 Date: Aug. 16, 2012

(30) Foreign Application Priority Data
Feb. 19, 2010 (KR) 10-2010-0015240

(51) Int. Cl. G03G 9/08

(52) U.S. Cl. 430/137.14

(57) ABSTRACT

Disclosed is a preparation method for a toner. Problems according to use of a surfactant can be solved and it is possible to prepare toner particles having a uniform distribution of particle size by using an alkali-soluble resin containing an acidic group.

### TECHNICAL FIELD

The present invention relates to a method of preparing a toner by using an alkali-soluble resin containing an acidic group, and more particularly, to a method of preparing a toner having a narrow particle size distribution, high glossiness, and high printing quality without using a surfactant.

### BACKGROUND ART

In general, toner is prepared by mixing a thermoplastic resin that functions as a binder resin, with a colorant, a wax, or the like. In addition, inorganic fine metal particles such as silica or titanium oxide may be added to toner as external additives in order to provide the toner with fluidity or improve its physical properties such as charge controlling properties or cleaning properties. Toner is prepared using a physical method such as pulverization or a chemical method such as suspension polymerization and emulsion aggregation.

Emulsion aggregation is a process of forming toner including preparing a resin emulsion by emulsion polymerization, and aggregating the resin emulsion with a pigment dispersion. By using the emulsion aggregation, problems such as high manufacturing costs and wide particle size distribution by the pulverization may be solved, and spherical toner particles may be obtained by controlling conditions for the aggregation.

In general, according to a method of producing toner by emulsion aggregation, toner particles are aggregated using a mixture of a binder resin in a latex phase, a colorant, and a wax using a coagulant, and the aggregated toner particles are coalesced. In this regard, a surfactant, such as an anionic surfactant, a cationic surfactant, and a non-ionic surfactant, may be used to prepare the latex. The surfactant forms aggregates such as micelles, and monomers dispersed in water enter the micelles to form a polymer.

U.S. Pat. No. 7,160,661, U.S. Pat. No. 6,617,091, U.S. Pat. No. 6,447,974, and U.S. Pat. No. 6,120,967 disclose processes of preparing a latex by using a surfactant and a monomer including a carboxyl group, and aggregation of toner particles using the processes.

The surfactant maintains a stability of latex particles. However, the surfactant deteriorates physical properties of the latex and affects following processes such as aggregation of toner. That is, a surfactant that is hydrophilic is disposed on the surface of the latex particles to stabilize the latex particles. However, this surface charge generates repulsive power between the particles during the aggregation, so that it is difficult to control the growth of particles.

The surfactant used in the preparation of the latex only stabilizes the latex particles and does not have other effects. In addition, if excess surfactant is used in order to reduce the particles size, the environment may be contaminated and waste water is generated. In addition, if the following process such as aggregation of toner particles is performed using the latex prepared as described above, the stability of the process may be deteriorated by the surfactant. Thus, the amount of the surfactant has been reduced. However, if the amount of the surfactant is reduced, the stability of latex may deteriorate, so that physical properties of the latex such as long-term storage may deteriorate. Particularly, a latex for the preparation of toner needs to be aggregated. Since the aggregation is a process of growing nanometer-sized particles to a large micrometer-sized particle, the aggregation is an important stage of the preparation of toner. In the aggregation process, the surfactant on a surface of the latex particles may intervene with the growth of the particles. That is, the aggregation behavior of toner particles may not be controlled according to the amount of an anionic or cationic surfactant disposed on the surface of the particles, and thus, a processing time for aggregation may vary. In addition, after toner is prepared, a washing process is performed to remove the surfactant. In this regard, a large amount of water is used, which is not economical.

Monomers having a carboxyl group are used for the preparation of the toner particles. These monomers that are disposed on the surface of the particles during the preparation of the latex accelerate the aggregation of toner particles due to the carboxyl group. That is, in a process of aggregating nanometer-sized toner particles by adding a metal salt, or the like, the metal salt functions as a medium where the carboxyl groups on the surface of the particles gather via electrostatic attraction.

Since skin may get burned by these acidic monomers having a carboxyl group, careful use is required. In addition, these monomers are expensive.

In addition, due to the carboxyl group of styrene acrylate copolymers commonly used in the art and strong hydrophilic groups of the surfactant, the aggregation process and the removal of the surfactant are not property performed, and properties of toner such as weather resistance and durability may deteriorate.

### DETAILED DESCRIPTION OF THE INVENTION

### Technical Problem

The present invention provides a method of preparing a toner having uniform particle size distribution where aggregation of toner particles is accelerated and an excessive washing process is not required since a surfactant is not used.

### Technical Solution

According to an aspect of the present invention, there is provided a method of preparing a toner, the method including:

dissolving an alkali-soluble resin containing an acidic group in an alkaline aqueous solution;

preparing a latex by adding a polymerizable monomer and a polymerization initiator to the solution of the alkali-soluble resin containing an acidic group;

adding a wax dispersion and a colorant dispersion to the latex;

aggregating the toner particles by adding a coagulant to the mixture of dispersions and homogenizing the mixture;

coalescing the aggregated toner particles; and

cooling the coalesced toner particles.

An acid value of the alkali-soluble resin containing an acidic group may be in the range of 10 to 360 mg KOH/g.

### Advantageous Effects

According to the preparation method of the present invention, the number of washing processes may be reduced, and toner having a uniform particle size distribution, and providing high gloss and high quality printing may be prepared.

### BEST MODE FOR CARRYING OUT THE INVENTION

Hereinafter, the present invention will now be described more fully with reference to the accompanying drawings, in which exemplary embodiments of the invention are shown.

A method of preparing a toner, according to an embodiment of the present invention, includes: dissolving an alkali-soluble resin containing an acidic group in an aqueous alkaline solution; preparing a latex by adding a polymerizable monomer and a polymerization initiator to the solution of the alkali-soluble resin containing an acidic group; adding a wax dispersion and a colorant dispersion to the latex; aggregating toner particles by adding a coagulant to the mixture of the dispersions and homogenizing the mixture; coalescing the aggregated toner particles; and cooling the coalesced toner particles.

In general, the “alkali-soluble resin (aqueous alkaline solution-soluble resin)” refers to a material soluble in an aqueous alkaline solution and having hydrophilic and hydrophobic parts. Thus, the alkali-soluble resin may provide a polymerization site in a similar manner to a general surfactant.

According to the current embodiment, toner particles may be prepared by using an alkali-soluble resin that functions as a general surfactant and contains an acidic group.

The acidic group may be a carboxyl group or a sulfonic acid group.

When the alkali-soluble resin containing an acidic group used herein may be dispersed in an aqueous alkaline solution including a neutralizer and purified water, the alkali-soluble resin may have the same properties as a surfactant. That is, since a reaction site where emulsion polymerization of a polymerizable monomer may occur is provided, a separate surfactant, particularly, an anionic surfactant is not required, the produced latex particles are stabilized, and time required for removing the surfactant may be considerably reduced. In addition, the alkali-soluble resin may replace a monomer containing a carboxyl group that is generally used in the polymerization of toner since the alkali-soluble resin has an acidic group, toner may be prepared in a cost effective manner, and bubbles that are generated by the surfactant during the preparation of the toner may be reduced, so that the content of fine particles and coarse particles may be minimized.

The alkali-soluble resin may include at least one selected from the group consisting of ethylene acrylic acid copolymer, styrene acrylic acid copolymer, and styrene maleic acid anhydride copolymer.

The neutralizer contained in the aqueous alkaline solution may be ammonium hydroxide, potassium hydroxide, sodium hydroxide, sodium carbonate, sodium bicarbonate, lithium hydroxide, potassium carbonate, triethylamine, triethanolamine, pyridine and derivatives thereof, diphenylamine and derivatives thereof, and poly(ethyleneamine) and derivatives thereof.

An amount of the alkali-soluble resin containing an acidic group may be in the range of 0.1 to 50% by weight based on the weight of the toner.

An acid value of the alkali-soluble resin containing an acidic group may be in the range of 10 to 360 mgKOH/g. If the acid value is within the range described above, the particles may be efficiently aggregated.

The method of preparing a toner, according to the current embodiment, will be described in more detail. First, an aqueous alkaline solution is added to a reactor, and then an alkali-soluble resin containing an acidic group is dissolved in the solution. A polymerizable monomer and a polymerization initiator are added to the solution of the alkali-soluble resin containing an acidic group to obtain a latex. A wax dispersion and a colorant dispersion are added to the latex and mixed, a coagulant is added thereto, and the mixture is homogenized to aggregate toner particles. The aggregated toner particles are coalesced and cooled to obtain target toner particles.

The polymerizable monomer used herein may be at least one monomer selected from the group consisting of: a styrene-based monomer such as styrene, methyl styrene, chlorostyrene, dichlorostyrene, p-tert-butylstyrene, p-n-butylstyrene, and p-n-nonylstyrener; a (meth)acrylic ester-based monomer such as acrylate, methyl acrylate, ethyl acrylate, propyl acrylate, isobutyl acrylate, n-butyl acrylate, beta carboxylethyl acrylate, hydroxyl acrylate, ethylhexyl acrylate, methacrylate, methyl methacrylate, ethyl methacrylate, propyl methacrylate, n-butyl methacrylate, isobutyl methacrylate, hydroxylethyl methacrylate, and ethylhexyl methacrylate; aminostyrene and quaternary ammonium salts thereof; a monomer having a nitrogen-containing heteroring such as vinylpyridine and vinylpyrrolidone; and acrylonitrile, butadiene, isoprene, and divinyl benzene.

Examples of the polymerization initiator may be potassium persulfate, ammonium persulfate, benzoyl peroxide, lauryl peroxide, sodium persulfate, hydrogen peroxide, t-butyl hydroperoxide, cumene hydroperoxide, p-menthane peroxide, peroxy carbonate, and a mixture thereof, but are not limited thereto.

The amount of the polymerzation initiator may be in the range of 0.1 to 10 parts by weight based on 100 parts by weight of the polymerizable monomer.

A wax and a colorant are respectively added to deionized water and a surfactant to prepare a wax dispersion and a colorant dispersion. The mixture of the latex, the wax dispersion, and the colorant dispersion is homogenized by adding a coagulant to the mixture to aggregate toner particles. Then, the aggregated toner particles are coalesced and cooled to obtain target toner particles.

The colorant may be used in the form of a pigment itself, or alternatively, in the form of a pigment master batch in which the pigment is dispersed in a resin.

The pigment may be selected from pigments that are commonly and commercially used, such as a black pigment, a cyan pigment, a magenta pigment, a yellow pigment, and a mixture thereof.

The amount of the colorant may be sufficient to color the toner and form a visible image by development, for example, in the range of 1 to 20 parts by weight based on 100 parts by weight of the binder resin.

Wax improves fixing properties of a toner image. Examples of the wax include polyalkylene wax, such as low molecular weight polypropylene and low molecular weight polyethylene, ester wax, carnauba wax, and paraffin wax. The amount of the wax contained in the toner may be in the range of 0.1 to 30% by weight based on the weight of toner.

Toner particles may be aggregated by homogenizing the mixture of the latex, the wax dispersion, and the colorant dispersion and controlling ionic strength by adding a coagulant thereto. The size and shape of the aggregated toner particles are controlled by the coalescence process.

Hereinafter, one or more embodiments will be described in detail with reference to the following examples. However, these examples are not intended to limit the purpose and scope of the invention.

### Example 1

### Preparation of Solution of Alkali-Soluble Resin Containing an Acidic Group

1336 g of deionized water, 357 g of alkali-soluble resin containing an acidic group (Hanwha L&C Corp. Soluryl 70) and 81 g of an ammonium hydroxide solution were added to a double-jacketed reactor, and the reactor was heated to 40° C. and stirred for about 1 hour to prepare a solution of an alkali-soluble resin containing an acidic group. Then, the reactor was cooled to room temperature. Here, an acid value of the obtained alkali-soluble resin containing an acidic group was in the range of 200 to 300 mgKOH/g, and the solution had a solid content of 20.0% by weight, a pH in the range of 6.5 to 9.0, and a viscosity of 30 cp.

### Preparation of Latex Using Alkali-Soluble Resin Containing Acidic Group

525.1 g of deionized water and the solution of the alkali-soluble resin containing an acidic group were added to a reactor, and the reactor was heated to 75° C. while stirring. 276.7 g of styrene, 87.4 g of butylacrylate, 1.31 g of 1,10-dodecanediol diacrylate (A-DOD), and 0.95 g of 1-dodecanethiol (nDM, Aldrich) were added to a separate reactor, and the monomers were mixed at room temperature for about 30 minutes. The reactor including the solution of the alkali-soluble resin containing an acidic group was heated to 75° C., and then a solution of 10.18 g of ammonium persulfate dissolved in 222.8 g of deionized water was added to the reactor at a time. While maintaining the temperature of the reactor at 75° C., the mixed monomers were added to the reactor for about 3 hours. When the adding is completed, a reaction was performed for about 5 hours, and the reactor was cooled to terminate the reaction.

### Preparation of Pigment Dispersion

540 g of a cyan pigment (Daicolor Pigment MFG. Co., Ltd., Japan, ECB303), 27 g of a surfactant (Dowfax 2A1), and 2,450 g of distilled water were added to a 4 L reactor equipped with a stirrer, a thermometer, and a condenser, and the reactor was slowly stirred for about 10 hours to prepare a pre-dispersion. Then, the pre-dispersion was dispersed four times at 1500 bar using a Ultimaizer (Armstec Ind. Co., Ltd.) until the particle size became 200 nm or less. As a result, a cyan pigment dispersion was obtained.

After the dispersion, the particle size of the cyan pigment was measured using a Multisizer 2000 (Malvern), and a D₅₀ was 170 nm.

### Preparation of Wax Dispersion

65 g of a surfactant (Dowfax 2A1) and 1,935 g of distilled water were added to a 5 L reactor equipped with a stirrer, a thermometer, and a condenser. While slowly stirring the mixture for about 2 hours at a high temperature, 1,000 g of wax (NOF, Japan, WE-5) was added to the reactor. The wax was dispersed for 30 minutes using a homogenizer (IKA, T-45). As a result, a wax dispersion was obtained.

After the dispersion, the particle size of the wax was measured using a Multisizer 2000 (Malvern), and a D₅₀ was 320 nm.

### Preparation of Toner

145.2 kg of the latex, 24.5 kg of the cyan pigment dispersion, 25.4 kg of the wax dispersion, and 405.7 kg of water were added to a double-jacketed reactor, and the reactor was stirred at 350 rpm for about 10 minutes using a stirrer. Then, high-shear stirring was performed at 5,000 rpm for about 30 minutes while adding 42.8 kg of a mixture of polyaluminumchloride and nitric acid (1:2) to the reactor for 30 minutes. The reactants were transferred to a 2 L reactor. The reactor was heated to 55° C. at a rate of 1° C./min and maintained for 3 hours while stirring at 350 rpm to perform aggregation of toner particles. In this regard, the particle size of toner particles measured using a Coulter Counter was 6.4 microns. Then, the reactor was stirred at 350 rpm for 30 minutes, and then the reactor was heated to 98° C. at a rate of 1° C./min and maintained at this temperature for 6 hours. Then, the reactor was cooled to room temperature, filtered, and washed using water. The washing was performed about four times, and the conductivity of the water after washing was about 2.0 μS. After washing, the resultant was dried to obtain target toner particles.

### Examples 2 to 5

Latex and toner particles were prepared in the same manner as in Example 1, except that the amounts of the alkali-soluble resin containing an acidic group were adjusted as shown in Table 1 below.

TABLE 1

| Component | Example 1 | Example 2 | Example 3 | Example 4 | Example 5 |
|---|---|---|---|---|---|
| Deionized | 525.1 | | | | |
| water (g) | | | | | |
| Styrene (g) | 276.7 | | | | |
| Butylacryl- | 87.4 | | | | |
| ate (g) | | | | | |
| Solution of | 60 | 70 | 80 | 150 | 200 |
| alkali- | | | | | |
| soluble | | | | | |
| resin (g) | | | | | |
| A-DOD¹ (g) | 1.31 | | | | |
| nDM² (g) | 0.95 | | | | |
| Initiator³ (g) | 10.18 | | | | |
| Glass | 59.1 ± 1.0 | | | | |
| transition | | | | | |
| temperature | | | | | |
| (° C.) | | | | | |
| Molecular | 72,000 ± 1,500 | | | | |
| weight | | | | | |
| (Mw) | | | | | |
| Acid value | 6.5 | 8 | 11 | 15 | 20 |
| (mgKOH/g) | | | | | |

| | |
|---|---|
| Average | 170 ± 8 |
| particle | |
| diameter | |
| (nm) | |

¹1,10-dodecanedioldiacrylate
²1-dodecanethiol (Aldrich)
³ammonium persulfate

Latexes having various acid values as described above were prepared, and it was identified that other physical properties of the latexes were not changed.

### Comparative Examples 1 to 3

Toner particles were prepared in the same manner as in Example 1, except that the alkali-soluble resin containing an acidic group dispersion was not used, and 2-CEA and surfactant Dawfax were used as shown in Table 2 below. The washing was performed 10 times in total. Upon comparing with Example 1, the washing took a longer time, and the conductivity of the water after washing was about 2.0 μS. A single washing process took about 40 to 60 minutes.

TABLE 2

| | Comparative | Comparative | Comparative |
|---|---|---|---|
| Component | Example 1 | Example 2 | Example 3 |
| Deionized water (g) | 525.1 | | |
| Styrene (g) | 276.7 | | |
| Butylacrylate (g) | 87.4 | | |
| 2-CEA¹ (g) | 16.2 | 20.0 | 24.0 |
| A-DOD (g) | 1.31 | | |
| CTA (g) | 0.95 | | |
| Dowfax (g) | 11.5 | | |
| initiator (g) | 10.18 | | |
| Glass transition | 59.1 ± 1.0 | | |
| temperature (° C.) | | | |
| Molecular weight (Mw) | 73,000 ± 1,500 | | |
| Acid value | 11 | 14 | 21 |

| | |
|---|---|
| Average particle | 173 ± 8 |
| diameter (nm) | |

¹2-carboxylethylacrylate

1: 2-carboxylethylacrylate

If a general surfactant was used as shown in Comparative Examples 1 to 3, the amount of water used in the washing process was about 5 to 9 times as much as that of Examples 1 to 5 in which the surfactant was not used. Thus, manufacturing costs and processing time increase.

An average particle diameter of the toner prepared as described above was measured as follows, and properties of toner particles were evaluated.

### Average Particle Diameter

The average particle diameter of the toner particles was measured using a Coulter Multisizer III (Backman Coulter, U.S.A.) in which aperture of 100 μm was used, and 50000 toner particles were measured.

GSDp and GSDv of the toner particles prepared above were calculated by Equations 1 and 2 below using average particle diameters measured using a Multisizer™ 3 Coulter Counter® (manufactured by Beckman Coulter Inc.). Aperture of 100 was used in the Multisizer™ 3 Coulter Counter, and an appropriate amount of a surfactant was added to 50 to 100 ml of ISOTON-II (Beckman Coulter Co.), as an electrolyte, and 10 to 15 mg of a sample to be measured was added thereto, and the resultant was dispersed in an ultrasonic dispersing apparatus for 5 minute to prepare a sample for the Multisizer™ 3 Coulter Counter.

$$\begin{matrix}GSDp = \sqrt{\frac{D 84 p}{D 16 p}} ( p \text{:} number of particles ) & Equation 1 \\ GSDv = \sqrt{\frac{D 84 v}{D 16 v}} ( v \text{:} volume ) & Equation 2\end{matrix}$$

TABLE 3

| | Average particle | |
|---|---|---|
| | diameter (μm) | GSD |
| Example 1 | 6.20 | 1.23 |
| Example 2 | 6.35 | 1.23 |
| Example 3 | 6.34 | 1.24 |
| Example 4 | 6.45 | 1.25 |
| Example 5 | 6.38 | 1.25 |
| Comparative Example 1 | 6.89 | 1.36 |
| Comparative Example 2 | 7.24 | 1.37 |
| Comparative Example 3 | 7.13 | 1.42 |

In Comparative Examples 1 to 3, toner has a GSD value of 1.36 or greater, and accordingly, it was identified that toner particles have a wide particle size distribution.

As described above, toner particles prepared by using the alkali-soluble resin containing an acidic group according to the present invention have excellent properties such as a narrow particle size distribution, and a washing process is not required compared to a preparation method using a surfactant. The toner particles may provide high gloss and high quality printing.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing a toner, the method comprising:
dissolving an alkali-soluble resin containing an acidic group in an aqueous alkaline solution;
preparing a latex by adding a polymerizable monomer and a polymerization initiator to the solution of the alkali-soluble resin containing an acidic group;
adding a wax dispersion and a colorant dispersion to the latex;
aggregating toner particles by adding a coagulant to the mixture of the dispersions and homogenizing the mixture;
coalescing the aggregated toner particles.

2. The method of claim 1, wherein an acid value of the alkali-soluble resin containing an acidic group is in the range of 10 to 360 mg KOH/g.

3. The method of claim 1, wherein the alkali-soluble resin containing an acidic group comprises at least one selected from the group consisting of ethylene acrylic acid copolymer, styrene acrylic acid copolymer, and styrene maleic acid anhydride copolymer.

4. The method of claim 1, wherein the amount of the alkali-soluble resin containing an acidic group is in the range of 0.1 to 50% by weight based on the weight of toner.

5. The method of claim 1, wherein the alkali-soluble resin containing an acidic group comprises a carboxyl group or a sulfonic acid group.

6. The method of claim 1, wherein the polymerizable monomer comprises at least one selected from a vinyl-based monomer, a polar monomer having an acidic group, a monomer having an unsaturated ester group, and a monomer having a fatty acid group.

7. The method of claim 6, wherein the polymerizable monomer comprises at least one monomer selected from the group consisting of styrene, vinyl toluene, a-methyl styrene, acrylic acid, methacrylic acid, methyl acrylate, ethyl acrylate, propyl acrylate, butyl acrylate, 2-ethylhexyl acrylate, dimethylaminoethyl acrylate, methyl methacrylate, ethyl methacrylate, butyl methacrylate, 2-ethylhexyl methacrylate, dimethylaminoethyl methacrylate, acrylonitrile, methacrylonitrile, acrylamide, metacrylamide, ethylene, propylene, butylenes, vinyl chloride, vinylidene chloride, vinyl fluoride, vinyl acetate, vinyl propionate, vinyl methyl ether, vinyl ethyl ether, vinyl methyl ketone, methyl isoprophenyl ketone, 2-vinylpyridine, 4-vinylpyridine, and N-vinyl pyrrolidone.
